(19) United States
(12) Patent Application Publication
(10) Pub. No.: US 2026/0089523 A1
(43) Pub. Date: Mar. 26, 2026

(54) METHOD AND TEST SYSTEM FOR TESTING A DEVICE UNDER TEST

(71) Applicant: Rohde & Schwarz GmbH & Co. KG, Muenchen (DE)

(72) Inventor: Andrew NAYLOR, Fleet (GB)

(21) Appl. No.: 18/895,839

(22) Filed: Sep. 25, 2024

(51) Int. Cl. H04W 24/08; H04W 60/00; H04W 84/04

(52) U.S. Cl. CPC H04W 24/08; H04W 60/00; H04W 84/042

(57) ABSTRACT

A method of testing a device under test is described, wherein a testing device and a device under test are provided. A network is provided by the testing device. The device under test connects with the network provided by the testing device. The device under test is prompted to delete User Equipment Route Selection Policies (URSPs) stored on the device under test. Further, a test system for testing a device under test is described.

### FIELD OF THE DISCLOSURE

Embodiments of the present disclosure relate to a method of testing a device under test. Further, embodiments of the present disclosure relate to test system for testing a device under test.

### BACKGROUND

In the state of the art, it is known to test devices under test, e.g., a user equipment like a mobile phone, by using a testing device like a radio communication tester. The tests relate to obtaining information about the device under test when used in a certain network, for instance a 5G network.

According to the 5G standard, User Equipment (UE) Route Selection Policy (URSP) is used by the device under test to determine if a detected application can be associated to an established Packet Data Unit (PDU) session. Therefore, a URSP may be pre-configured in the device under test or it may be provisioned in the device under test by the network.

Depending on the history of the device under test, namely any previous tests performed, the device under test may comprise a URSP which may have an effect on the tests to be performed.

Therefore, the device under test should be clear prior to being tested. In the state of the art, measures are known to ensure clearness of the device under test, which however are complex as they rely on verifying the URSP by the testing device to perform certain tests which take the URSP into account, e.g., the history of the device under test, namely the previous usage of the device under test.

Accordingly, there is a need for a simplified solution to ensure proper testing of the device under test.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a method of testing a device under test. In an embodiment, the method comprises providing a testing device, providing a device under test, providing, by the testing device, a network, connecting the device under test with the network provided by the testing device, and prompting the device under test to delete stored User Equipment Route Selection Policies (URSPs).

Further, embodiments of the present disclosure also relate to a test system for testing a device under test. In an embodiment, the test system comprises a testing device and a device under test. The testing device is configured to provide a network for the device under test and the device under test is configured to register to the network provided by the testing device. The testing device is also configured to prompt the device under test to delete any stored User Equipment Route Selection Policies (URSPs).

The main idea is to clear the device under test by prompting the device under test to delete its stored User Equipment Route Selection Policies (URSPs). Hence, it is ensured that the device under test does not comprise any URSPs from former tests or usage. Therefore, it is not necessary that the provisioning is part of the testing. In other words, the testing can be done in a simplified manner since the testing device does not have to take any URSPs provisioned into account since the device under test relates to a clear device under test, namely a device under test without any URSPs. Put differently, it is not necessary for the testing device to verify the URSPs which depend on the previous usage of the device under test. To the contrary, the URSPs are deleted from the device under test such that the testing device does not have to take any previous usage of the device under test into account.

An aspect provides that all stored User Equipment Route Selection Policies (URSPs), for example, are deleted. Hence, the testing device is configured to delete all stored User Equipment Route Selection Policies (URSPs). As indicated above, all URSPs are deleted from the device under test such that the device under test is completely cleared with regard to any prior testing. Hence, the device under test may have been used in previous tests and, thus, the device under test may have been previously provisioned with URSPs. This however does not affect the current testing, as all URSPs are deleted, for example regardless of any Public Land Mobile Network (PLMN) or URSP identification.

Another aspect provides that the testing device, for example, transmits a deletion command to the device under test, thereby prompting the device under test to delete the User Equipment Route Selection Policies (URSPs) stored. In other words, the testing device is configured to transmit a deletion command to the device under test, thereby prompting the device under test to delete the stored User Equipment Route Selection Policies (URSPs). Hence, the URSPs are deleted automatically, namely triggered by the testing device. No manual interaction is required accordingly.

Generally, the deletion command relates to a test command that is processed by the device under test without providing, for example, a feedback to the testing device.

Moreover, the device under test may indicate the User Equipment Route Selection Policies (URSPs) stored. In other words, the device under test is configured to indicate the User Equipment Route Selection Policies (URSPs) stored. The device under test may report the URSPs stored to the testing device nevertheless, which however do not have to be taken into account by the testing device, as the URSPs are deleted anyway.

For instance, the User Equipment Route Selection Policies (URSPs) are indicated automatically by the device under test when registering to the network provided by the testing device. In other words, the device under test is configured to indicate the stored User Equipment Route Selection Policies (URSPs) automatically when registering to the network provided by the testing device. The telecommunication standard used by the device under test may define that the device under test reports the URSPs when registering to a network automatically. Even though the URSPs are not used by the testing device, the device under test may automatically report the URSPs by default, e.g., due to requirements of the telecommunication standard used by the device under test.

In an embodiment, the URSPs indicated might be used in other tests.

A further aspect provides that the device under test, for example, indicates the User Equipment Route Selection Policies (URSPs) for each Public Land Mobile Network (PLMN). The respective information may be forwarded for different networks.

Moreover, all User Equipment Route Selection Policies (URSPs) for each Public Land Mobile Network (PLMN) may be indicated. Hence, all information stored in the device under test with regards to URSP may be forwarded accordingly.

As indicated above, the indication/reports of the URSPs may relate to requirements of the telecommunication standard, but they are not necessary for the testing device, as the URSPs are deleted anyway, e.g., prompted by the testing device, thereby obtaining a device under test without history with respect to prior testing/usage, as not URSPs are stored when a testing by the method or the test system according to the present disclosure is initiated.

In an embodiment, the User Equipment Route Selection Policies (URSPs) are indicated in form of a UE Policy Section Identifier (UPSI) list with a Public Land Mobile Network (PLMN) identification part and a UE policy section code (UPSC) part. In an embodiment, each UE policy section might be identified by a UE policy section identifier (UPSI). The UPSI is composed of two parts, namely a PLMN ID part containing the PLMN ID for the PLMN of the Policy Control Function (PCF), which provides the UE policies as well as a UE policy section code (UPSC) containing a unique value within the PLMN selected by the PCF.

According to a further aspect, a test campaign is started after the User Equipment Route Selection Policies (URSPs) were deleted. The test campaign can be started with a clear device under test, namely a device under test that does not have any URSPs stored from prior usage/testing.

The device under test may be a user equipment. For example, the user equipment may be a mobile phone or a tablet. In addition, the testing device can be a radio communication tester. In an embodiment, the radio communication tester may be configured to provide different kinds of networks for testing the device under test, e.g., a 5G network, a 5G NR network, or a 6G network.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an overview of a test system according to an embodiment of the present disclosure;

FIG. 2A schematically shows an overview of a method according to the state of the art; and

FIG. 2B schematically shows an overview of a method according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

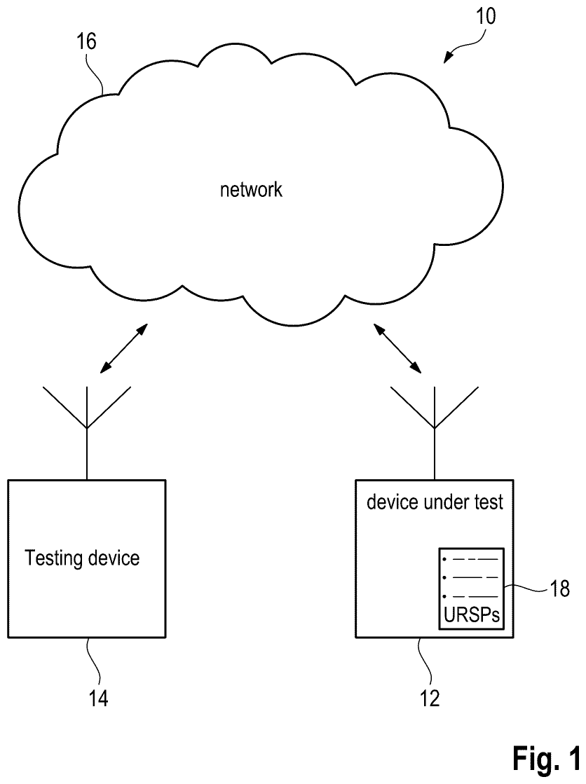

FIG. 1 schematically shows a representative test system 10 that comprises a device under test 12 as well as a testing device 14. The device under test 12 may relate to a user equipment, for instance a mobile phone or a tablet. The testing device 14 is generally enabled to provide a network 16 to which the device under test 12 can connect for testing purposes, for instance a 5G network.

The device under test 12 may have been used previously or tested in a former test campaign such that User Equipment Route Selection Policies (URSPs) 18 may be stored on the device under test 12 as schematically indicated in FIG. 1.

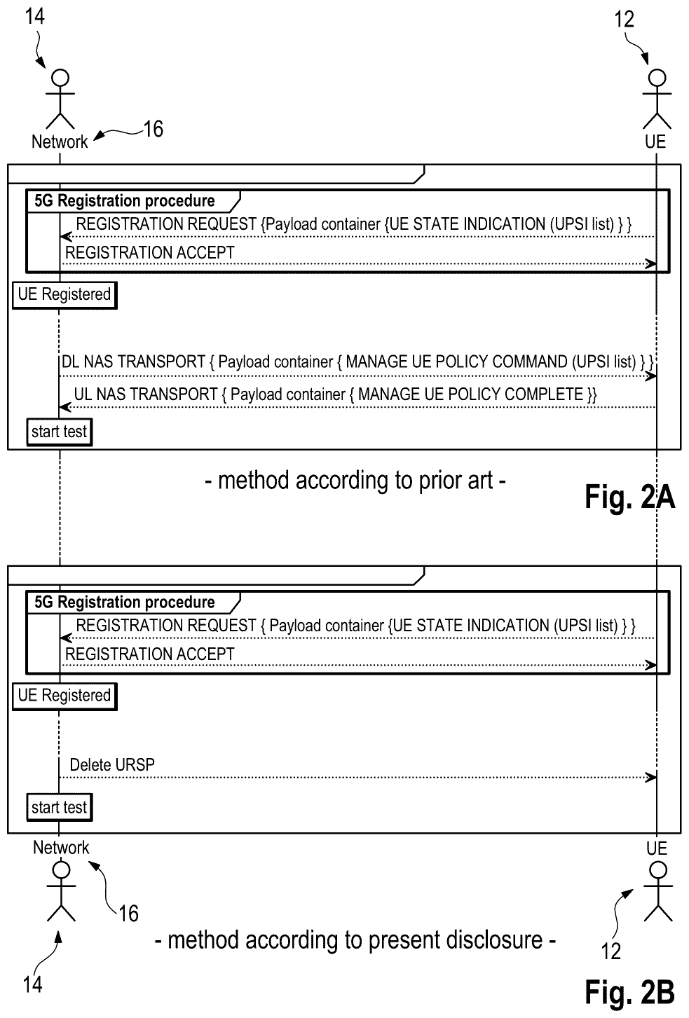

As indicated in FIG. 2, the device under test 12 typically reports the URSPs stored in the form of a UE Policy Section Identifier (UPSI) list when registering to the network 16 established by the testing device 14. Thus, the testing device 14 is aware of the URSPs stored. Generally, the UPSI list comprises a Public Land Mobile Network (PLMN) identification part and a UE policy section code (UPSC) part. Hence, the device under test 12 reports the User Equipment Route Selection Policies (URSPs) for each Public Land Mobile Network (PLMN), for example all User Equipment Route Selection Policies (URSPs) for each Public Land Mobile Network (PLMN) when registering to the network 16 provided by the testing device 14.

In the state of the art illustrated in FIG. 2A, e.g., the upper part, the testing device 14 processes the information with regard to the URSPs reported while transmitting a downlink non-access stratum transport (DL NAS TRANSPORT) message which is processed by the device under test 12 that in turn reports back an uplink non-access stratum transport (UL NAS TRANSPORT) message to the testing device 14 prior to starting the test campaign. Two payload container types are defined, namely in the downlink (DL NAS TRANSPORT message) and the uplink (UL NAS TRANSPORT message), which are used to enable transfer of location services signaling messages. Put differently, the testing device 14 and the device under test 12 had to exchange messages, namely a “MANAGE UE POLICY COMMAND” message and a “MANAGE UE POLICY COMPLETE” message.

In contrast thereto, the method according to the present disclosure, as illustrated in FIG. 2B, makes use of prompting the device under test 12 to delete User Equipment Route Selection Policies (URSPs) 18 stored on the device under test 12.

In an embodiment, the testing device 14 transmits a deletion command to the device under test 12, thereby prompting the device under test 12 to delete all URSPs 18 stored. Thus, the device under test 12 is cleared of all URSPs. Hence, no information with regard to a former test campaign will remain stored on the device under test 12, thereby simplifying testing of the device under test 12.

In an embodiment, the deletion command relates to a test command that does not require any feedback from the device under test 12.

Even though the testing device 14 does not process the information forwarded with regard to the URSPs 18 stored, the device under test 12 reports the stored URSPs 18 to the testing device 14 automatically when registering to the network 16 provided by the testing device 14, namely by the registration request.

Instead of processing the information received from the device under test 12, the testing device 14 simply commands the device under test 12 to delete all URSPs 18 stored so as to clear itself.

Accordingly, the test campaign can be started with a clear device under test 12, namely a device under test 12 that is not pre-configured or provisioned with regard to URSP(s). In other words, it can be ensured that the device under test 12 will be configured from scratch by the test campaign rather than using configured data from a previous test.

Hence, it can also be verified that the test campaign correctly configured the device under test 12 for the tests to be performed in the course of the test campaign.

Since the deletion command does not require a verification of the messages exchanged, a simpler solution is provided to obtain a clear device under test 12 for performing the intended tests.

In an embodiment, a command is sent via the network 16 to the device under test 12 to delete all provisioned URSP rules stored without having to specify the UPSI list.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as the device under test 12, the testing device 14, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuity to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B. ”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method of testing a device under test, the method comprising the steps of:
providing a testing device;
providing a device under test having User Equipment Route Selection Policies (URSPs) stored thereon;
providing, by the testing device, a network;
connecting the device under test with the network provided by the testing device; and
prompting the device under test to delete the User Equipment Route Selection Policies (URSPs) stored on the device under test.

2. The method according to claim 1, wherein all User Equipment Route Selection Policies (URSPs) stored on the device under test are deleted.

3. The method according to claim 1, wherein the testing device transmits a deletion command to the device under test, thereby prompting the device under test to delete the User Equipment Route Selection Policies (URSPs) stored on the device under test.

4. The method according to claim 1, wherein the device under test indicates the User Equipment Route Selection Policies (URSPs) stored on the device under test.

5. The method according to claim 1, wherein the User Equipment Route Selection Policies (URSPs) are indicated automatically by the device under test when registering to the network provided by the testing device.

6. The method according to claim 1, wherein the device under test indicates the User Equipment Route Selection Policies (URSPs) for each Public Land Mobile Network (PLMN).

7. The method according to claim 1, wherein all User Equipment Route Selection Policies (URSPs) for each Public Land Mobile Network (PLMN) are indicated.

8. The method according to claim 1, wherein the User Equipment Route Selection Policies (URSPs) are indicated in form of a UE Policy Section Identifier (UPSI) list with a Public Land Mobile Network (PLMN) identification part and a UE policy section code (UPSC) part.

9. The method according to claim 1, wherein a test campaign is started after the User Equipment Route Selection Policies (URSPs) were deleted.

10. The method according to claim 1, wherein the device under test is a user equipment.

11. The method according to claim 1, wherein the testing device is a radio communication tester.

12. A test system for testing a device under test, the test system comprising:
a testing device; and
a device under test having User Equipment Route Selection Policies (URSPs) stored thereon,
wherein the testing device is configured to provide a network for the device under test, wherein the device under test is configured to register to the network provided by the testing device, and wherein the testing device is configured to prompt the device under test to delete any User Equipment Route Selection Policies (URSPs) stored on the device under test.

13. The test system according to claim 12, wherein the testing device is configured to delete all User Equipment Route Selection Policies (URSPs) stored on the device under test.

14. The test system according to claim 12, wherein the testing device is configured to transmit a deletion command to the device under test, thereby prompting the device under test to delete the User Equipment Route Selection Policies (URSPs) stored on the device under test.

15. The test system according to claim 12, wherein the device under test is configured to indicate the User Equipment Route Selection Policies (URSPs) stored on the device under test.

16. The test system according to claim 12, wherein the device under test is configured to indicate the User Equipment Route Selection Policies (URSPs) stored on the device under test automatically when registering to the network provided by the testing device.

17. The test system according to claim 12, wherein the device under test is a user equipment.

18. The test system according to claim 12, wherein the testing device is a radio communication tester.
